(19) United States
(12) Patent Application Publication
(10) Pub. No.: US 2016/0295642 A1
(43) Pub. Date: Oct. 6, 2016

(54) Device for Controlling a Heat-Regulating Appliance and a Method for Using the Same

(71) Applicant: TRANBERG AS, Stavanger (NO)

(72) Inventor: Kjell Are BERG-HAGEN, Stavanger (NO)

(73) Assignee: Tranberg AS, Stavanger (NO)

(21) Appl. No.: 15/037,837

(22) PCT Filed: Oct. 29, 2014
(86) PCT No.: PCT/NO2014/050202

§ 371 Date: May 19, 2016

(30) Foreign Application Priority Data
Nov. 20, 2013 (NO) 20131551

(51) Int. Cl. H05B 3/56; G05D 23/24; H05B 1/02

(52) U.S. Cl. CPC H05B 3/56; H05B 1/023; H05B 1/0202; G05D 23/2401; H05B 2203/02; H05B 2214/02

(57) ABSTRACT

A device is for controlling a temperature-regulating appliance. The device comprises: a sensor arranged to be able to sense effective temperature by the temperature-regulating appliance and to submit a signal as indication of the sensed effective temperature; a control unit arranged to be able to receive the signal from the sensor as an indication for sensed effective temperature and to be able to control the power supply to the temperature-regulating appliance based on the received signal indicating for effective temperature; and one or more energy sources arranged to at least be able to drive the sensor, the control unit and the temperature-regulating appliance. The sensor is constituted by a self-regulating heater cable. A method is for use of a device for control of a temperature-regulating appliance.

### FIELD

The present invention concerns a device for controlling a temperature-regulating appliance. More specifically the invention concerns a device comprising a sensor arranged to be able to sense effective temperature by the temperature-regulating appliance and to submit a signal as indication of the sensed effective temperature, a control unit arranged to be able to receive the signal from the sensor as an indication for sensed effective temperature and to be able to control the power supply to the temperature-regulating appliance based on the received signal indicating for effective temperature.

### BACKGROUND

Self-regulating heater cables are made such that the amount of current passing through the heater cable is a function of the ambient temperature. A part of the electrical conductor in such a self-regulating heater cable has a coefficient of thermal conductivity which is in inverse ratio to the temperature. This means that a self-regulating heater cable which adjoins a cold surface may lead relatively large amounts of current, and thereby emit a relatively high power, whereas a corresponding heater cable which adjoins a hot surface will lead less current, and thus emit less power. Self-regulating heater cables could therefore be said to be their own thermostat.

Heater cables which are used outdoors may in particularly exposed situations need large amounts of power in order to keep a desired area free from ice. This may for instance be on board a ship, even though the invention is not limited to that. When using heater cables in a ship deck or in steps outside on the ship, the heater cables may preferably be placed relatively deep such that the heater cables are not in direct contact with the surroundings. For this reason self-regulating heater cables may not be used for directly controlling the admission to the heater cables, and therefore in periods a lot more energy than what is needed may be used for heating. Furthermore, it is known that wind influences on the sensed temperature and that areas especially exposed to wind requires more heating than areas less exposed to wind. Sensors which also take consideration of wind force, may comprise mechanically moveable parts, and thus are particularly exposed to wear under harsh weather conditions.

### SUMMARY

The invention has for its object to remedy or to reduce at least one of the drawbacks of the prior art, or at least to provide a useful alternative to prior art.

The object is achieved through features, which are specified in the description below and in the claims that follow.

In a first aspect the invention relates more particularly to a device for controlling a temperature-regulating appliance, wherein the device comprises:
a sensor arranged to be able to sense effective temperature by the temperature-regulating appliance and to submit a signal as indication of the sensed effective temperature;
a control unit arranged to be able to receive the signal from the sensor as an indication for sensed effective temperature and to be able to control the power supply to the temperature-regulating appliance based on the received signal indicating for effective temperature; and
one or more energy sources arranged to at least be able to drive the sensor, the control unit and the temperature-regulating appliance, distinguished by the sensor being constituted by a self-regulating heater cable.

A self-regulating heater cable will be able to sense effective temperature in a simple, efficient and inexpensive way, without moveable parts and without the need for a thermostat and a lot of electronics. Efficient sensed temperature could be a function of actual temperature, wind speed and air humidity and other local conditions.

A device according to the invention could be used for cooling as well as for heating. The temperature-regulating appliance may thus be different heating devices or cooling devices which will be known to the skilled person. In one embodiment the temperature-regulating appliance may be a heater cable. The heater cable which then is possibly used as a temperature-regulating appliance, will then not be the same as the self-regulating heater cable which is used as sensor in the device in accordance with the invention.

In one embodiment the self-regulating heater cable, the sensor, may be arranged in an encapsulation which ensures good contact with the surroundings at the same time as it provides mechanical protection. The encapsulation may for instance be a perforated receptacle.

In one embodiment the device may further comprise one or more signal converters arranged to be able to convert the sensed signal from the sensor. The output signal from the self-regulating heater cable will not necessarily be directly proportional to a theoretically calculated signal, thus an adaptive signal processing algorithm may be required. Said signal converter(s) may be a so-called pulse-width modulator, PWM. A skilled person will know that the object of a PWM is to obtain an approximately continuous, steady admission, in this case to said temperature-regulating appliance. The pulse-width modulated signal may further be sent to a switch, for instance a relay, for example a semi-conductor relay, which causes that energy supply to the temperature-regulating appliance is either on or off. The on-time of the switch in percentages, the so-called duty cycle, will be decided by the output signal from the sensor, and thus the need for change of temperature, which may be heating or cooling.

A vessel comprising a device in accordance with the present invention is described.

Further, a platform comprising a device in accordance with the present invention is described.

A helicopter deck comprising a device in accordance with the present invention is also described.

A plurality of devices in accordance with the present invention may be used on said vessel, platform or helicopter deck in order to make possible a local, optimized heating.

In a second aspect the invention relates to use of a self-regulating heater cable as a sensor for effective temperature by controlling a temperature-regulating appliance.

In a third aspect the invention concerns a method for control of a temperature-regulating appliance, wherein the method comprises the steps:
by means of a sensor to sense effective temperature by the temperature-regulating appliance;
by means of the sensor to submit a signal as indication of the sensed effective temperature;
by means of a control unit to receive the signal from the sensor as indication of sensed effective temperature;
by means of the control unit to guide the power supply to the temperature-regulating appliance; and
by means of one or more energy-sources to drive the sensor, the control unit and the temperature-regulating appliance, distinguished by the step of sensing effective temperature by means of a sensor including sensing effective temperature by means of a self-regulating heater cable.

In one embodiment it would be advantageous if the signal emitted from the self-regulating heater cable was calibrated such that a given current drawn from the self-regulating heater cable corresponds to a given admission to the temperature-regulating appliance. The calibration may be known in the art, but may depend on the area of use and location. This will make possible the use of an open loop, i.e. no reversal of the measured values is required in order to complete the control of the temperature-regulating appliance. In an alternative embodiment the regulation may be done in a closed loop, i.e. with reversal of measured values. The latter may for instance be carried out by means of a PID-regulator as will be known to the skilled person.

In one embodiment the method may further comprise to control a switch by means of the control unit such that the power supply from one of the one or more energy sources of the temperature-regulating appliance is turned off and on. This may be done through a regulating algorithm incorporated in the control unit such that the control may be done in an open loop as described above. An open loop solution may save considerable costs due to reduced need for transmitters of measured values and signal cables.

### BRIEF DESCRIPTION OF THE DRAWING

In the following is described an example of a preferred embodiment illustrated in the accompanying drawing, wherein:

FIG. 1 shows, schematically and simplified, a device in accordance with the present invention.

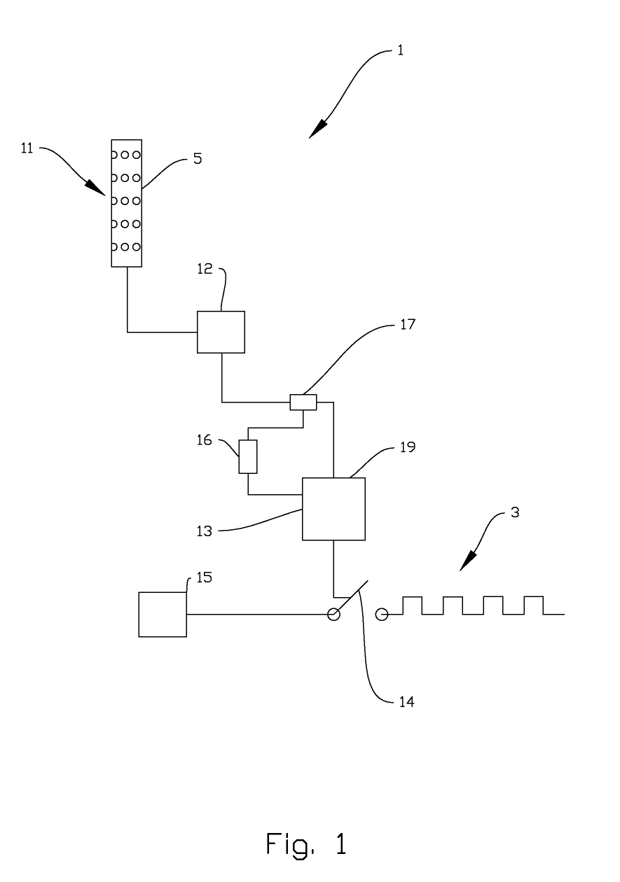

### DETAILED DESCRIPTION OF THE DRAWING

In the following the reference numeral 1 denotes a device in accordance with the present invention. Cables for transmission of electricity and/or communication signals between the different units which are mentioned in the following, is shown as straight lines between the units in the drawing. The cables will be known to a person skilled in the art and will not be further described herein. A person skilled in the art will also be familiar with the fact that communication between two different units may be wireless.

A sensor 11 in the form of a self-regulating heater cable is arranged in a perforated encapsulation 5. The encapsulation 5 may be placed on the deck on board a not shown vessel. The encapsulation 5 provides mechanical protection for the self-regulating heater cable 11 at the same time as the heater cable is exposed to the ambient temperature-, wind-, and humidity conditions. An energy source 12 is connected to the self-regulating heater cable 11. The energy source 12 supplies constant voltage. As described above, the amount of current which passes through the self-regulating heater cable 11 is regulated by the effective ambient temperature. The power drawn from the energy source 12 thus will provide a measure of heat loss in the self-regulating heater cable 11, and thus an indirect measure of the effective temperature. The signal/power drawn from the energy source 12 is read and transferred to a signal processing unit 17. In the shown example the signal processing unit 17 transforms the emitted signal from the self-regulating heater cable 11 to a readable signal for a control unit 13. The control unit 13 and the signal processing unit 17 are connected to an is energy source 16. The control unit 13, which is typically a PLC, a micro controller or the like, will be arranged and calibrated to transform the received signal from the signal processing unit 17 into an output signal for control of a temperature-regulating appliance 3. In the shown example the signal processing unit 17 transforms the signal from the power source 12 to a voltage signal, for instance in the interval 0 to 5 V. On the basis of the read voltage in the control unit 13, the read voltage signal is transformed, by means of the signal transducer 19 integrated in the control unit 13, to a pulse-width modulated signal as described in the above. The pulse-width modulated signal controls a switch 14, here shown schematically as a mechanical relay, which regulates the energy supply to the temperature-regulating appliance 3 from an energy source 15. Pulse peaks in the pulse-width modulated signal, corresponds to on-time for the switch 14, whereas pulse troughs corresponds to off-time. The on-time, or so-called duty cycle, of the pulse-width modulated signal will depend on the voltage level of the input signal from the control unit 13. A voltage level above a set upper value within said voltage interval, will give 100% on-time, whereas a voltage level below a lower limit within said voltage interval, will give 0% on-time. Voltage levels between said upper limit and lower limit, give partly on- and partly off-time.

1. A device for controlling a temperature-regulating appliance, wherein the device comprises:
a sensor arranged to be able to sense effective ambient temperature by the temperature-regulating appliance and to submit a signal as indication of the sensed effective temperature;
a control unit arranged to be able to receive the signal from the sensor as an indication for sensed effective ambient temperature and to be able to control the power supply to the temperature-regulating appliance based on the received signal indicating for effective ambient temperature; and
one or more energy sources arranged to at least be able to drive the sensor, the control unit and the temperature-regulating appliance;
wherein the sensor is constituted by a self-regulating heater cable.

2. The device according to claim 1, wherein the device further comprises one or more signal-converters arranged to be able to convert the sensed signal from the sensor.

3. The device according to claim 1, wherein the device further comprises a switch, wherein the switch is adapted to be able to be controlled by the control unit, and wherein the switch is adapted to be able to turn off and on the power supply from at least one of said one or more energy sources to the temperature-regulating appliance.

4. The device according to claim 1, wherein the temperature-regulating appliance is a heater cable.

5. A vessel comprising a device according to claim 1.

6. A platform comprising a device according to claim 1.

7. A helicopter deck comprising a device according to claim 1.

8. Use of a self-regulating heater cable as a sensor for effective ambient temperature when controlling a temperature-regulating appliance.

9. A method for control of a temperature-regulating appliance, wherein the method comprises:
with a sensor, sensing effective ambient temperature by the temperature-regulating appliance;
with the sensor, submitting a signal as indication of the sensed effective ambient temperature;
with a control unit, receiving the signal from the sensor as indication of sensed effective ambient temperature;
with the control unit, guiding the power supply to the temperature-regulating appliance; and
with one or more energy sources, driving the sensor, the control unit and the temperature-regulating appliance,
wherein sensing effective ambient temperature with a sensor comprises sensing effective ambient temperature with a self-regulating heater cable.

10. The method according to claim 9, wherein the method further comprises controlling a switch with the control unit such that the power supply from one of the one or more energy sources of the temperature-regulating appliance is turned off and on.
